(19) United States
(12) Patent Application Publication
(10) Pub. No.: US 2015/0070297 A1
(43) Pub. Date: Mar. 12, 2015

(54) CONTROL METHOD FOR TOUCH PANEL

(71) Applicant: WALTOP INTERNATIONAL CORPORATION, Hsinchu City (TW)

(72) Inventors: CHUNG-FUU MAO, Hsinchu City (TW); CHIA-JUI YEH, Taipei City (TW)

(73) Assignee: WALTOP INTERNATIONAL CORPORATION, Hsinchu City (TW)

(21) Appl. No.: 14/099,934

(22) Filed: Dec. 7, 2013

Related U.S. Application Data
(60) Provisional application No. 61/875,156, filed on Sep. 9, 2013.

(51) Int. Cl. G06F 3/046

(52) U.S. Cl. CPC G06F 3/046
USPC 345/174

(57) ABSTRACT

A control method for a touch panel is disclosed. First of all, a step of detecting an electromagnetic and capacitive pen is performed. Next a step of detecting a conductive indicator is undertaken, followed by a step of detecting a signal value of the conductive indicator being performed. A step of determining whether the signal value is over a threshold value is then performed to determine whether a first or a second touch control modes. The touch panel has electromagnetic sensitive and capacitive touch control functions.

### BACKGROUND OF THE INVENTION

1. Field of the Invention

The present invention generally relates to touch panels, and more particularly to a control method for a touch panel with electromagnetic sensitive and capacitive touch control functions.

2. Description of the Related Art

Touch displays combining sensor and display technologies to form input/output modules such as touch panels are commonly used in electronic appliances, such has portable and handheld electronic devices.

Touch input technology can be categorized according to the type of contact object, such as the user's finger(s), a digital pen or an electromagnetic pen or a stylus, as well as the way of determining the location of the point of contact, such as the location or distance as the contact object approach. Depending on the above, touch input technology can be categorized as resistance type, capacitive type, electromagnetic type and Infrared type touch technologies.

Capacitive type touch panel is the most commonly used touch panel, which uses capacitive coupling effects to detect touch location. When conductive pointers such as a user's finger(s) approach or touch the surface of the capacitive touch panel, capacitance(s) corresponding to the touch location(s) will be altered and thus the touch location(s) is able to be detected. A touch panel contains a sensor layer which can store charges. Sensors located around the touch panel apply an electric field on the surface of the touch panel and form a capacitor.

For a passive touch source, such as a user's finger or a conductive device, when the touch source contacts the surface of the touch panel, electric currents are generated between the touch source and the sensors of the touch panel. Coordinates of touch points on the touch panel can be calculated through different electric currents generated between different sensors and the touch source. Since a passive type touch panel must be used with a conductor, a normal passive type touch panel will not work well when it is used with an non-conductive touch source such as a user with a glove or an non-conductive stylus. In an active type capacitive touch panel, sensors generate signal currents to calculate coordinates of touch points on a touch panel when the sensors detect contacts from a touch source, usually a conductive touch source.

Capacitive touch input technology offers the advantages of allowing use of a variety of touch sources such as a user's finger(s) for input operation and multi-touch gestures for various operations and functions. Various applications can be assigned corresponding to multi-touch gestures.

Electromagnetic-type input technology applies electromagnetic and capacitive pens as the input device with induction sensor coils. Electromagnetic and capacitive pens offer advantages including convenience for writing, tip pressure level function, and certain sensing height, and further have side button (as right button or middle button) functions as well as electromagnetic pen tail eraser functions to increase the diversity and flexibility of use.

Although electromagnetic type input technology has advantages of convenience for writing, tip pressure level function, and certain sensing height as mentioned above, a user's finger(s) or other touch sources will not work and a particular stylus must be used for input operation.

Thus, integrating both electromagnetic and capacitive input technologies into a touch panel will offer both advantages thereof and significantly increase convenience of use. New technologies directly omit the substrate for supporting electromagnetic induction sensor coils and form electromagnetic induction sensor coils on a peripheral area of a sensor layer of a touch panel.

Thus, the invention provides a control method for a touch panel with electromagnetic sensitive and capacitive touch control functions.

### SUMMARY OF THE INVENTION

An object of the present invention is to provide a control method for a touch panel with electromagnetic sensitive and capacitive touch control functions.

According to a control method for a touch panel of the invention, a step of detecting an electromagnetic and capacitive pen is first performed. Then, a step of determining whether an electromagnetic and capacitive pen exists is performed. If the electromagnetic and capacitive pen exists, a first touch control mode is performed. If the electromagnetic and capacitive pen does not exist, a step of detecting a conductive indicator is performed. Next a step of determining whether a conductive indicator exists or not is performed. If the conductive indicator does not exist, then the step of determining whether an electromagnetic and capacitive pen exists is performed again. If the conductive indicator exists, a step of detecting signal value of the conductive indicator is performed. Next, a step of determining whether the signal value is over a threshold value is performed to determine whether a first or a second touch control mode is performed. If the signal value is not over the threshold value, the first touch control mode is performed. Finally, if the signal value is over the threshold value, the second touch control mode is performed. In one embodiment of the invention, the control method for a touch panel can be built in as a firmware program of the main controller or a processor.

### BRIEF DESCRIPTION OF THE DRAWINGS

FIG. 1 shows a schematic diagram of touch control operation upon a touch panel according to one embodiment of the invention.

FIG. 2 shows a block diagram of a touch control display.

FIG. 3 shows a capacitive type substrate according to one embodiment of the invention.

FIG. 4A and FIG. 4B show schematic diagrams of characteristics of self capacitance mode.

FIG. 4C shows a schematic diagram of capacitance calculation of self capacitance mode.

FIG. 4D shows schematic diagrams of characteristics of mutual capacitance mode.

FIG. 4E shows a schematic diagram of capacitance calculation of mutual capacitance mode.

FIG. 5 is a flow chart of a control method for a touch panel according to one embodiment of the invention.

### DETAILED DESCRIPTION OF THE INVENTION

Various example embodiments of the present invention will now be described more fully with reference to the accompanying drawings in which some example embodiments of the invention are shown. In the drawings, the size of every component may be exaggerated for clarity.

Detailed illustrative embodiments of the present invention are disclosed herein. However, specific structural and functional details disclosed herein are merely representative for purposes of describing example embodiments of the present invention. This invention may, however, be embodied in many alternate forms and should not be construed as limited to only the embodiments set forth herein.

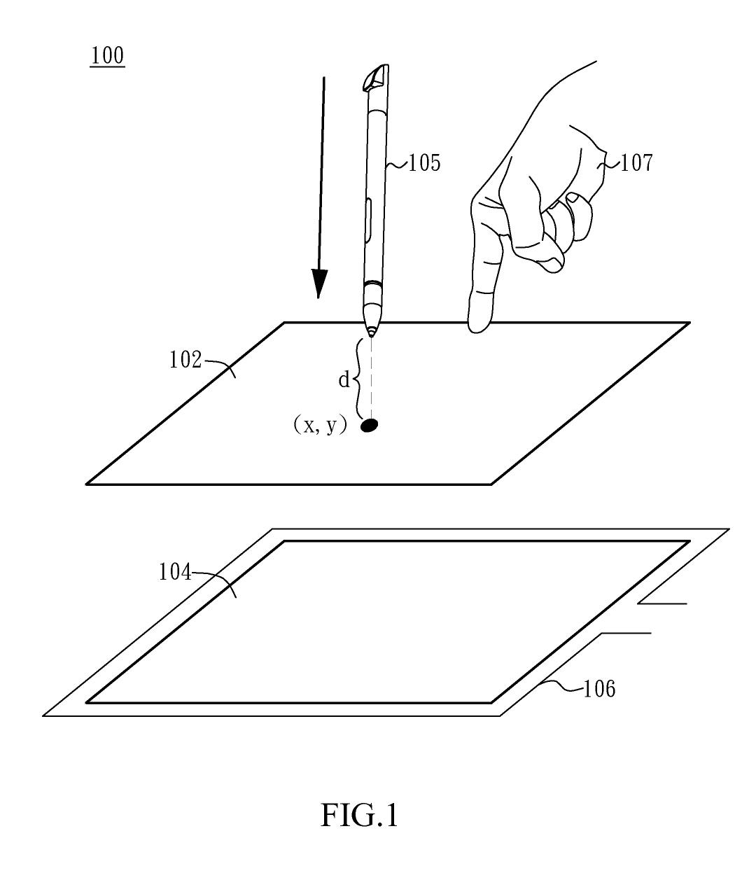

FIG. 1 shows a schematic diagram of touch control operation upon a touch panel according to one embodiment of the invention. A touch panel 100 with electromagnetic sensitive and capacitive touch control functions comprises a cover lens 102 and a capacitive type substrate. Well known elements such as a liquid crystal panel under the capacitive type substrate are omitted herein. The cover lens 102 comprises, but is not limited to, a glass panel. The capacitive type substrate comprises a capacitive type sensor layer 104, a sensor coil 106 and a transparent substrate. In one embodiment of the invention, the capacitive type sensor layer 104 and the sensor coil 106 are formed on the transparent substrate. The capacitive type substrate is usually located above a liquid crystal panel of the touch panel 100. The transparent substrate comprises a glass substrate.

The capacitive type sensor layer 104 comprises a plurality of detection electrodes and traces connecting the detection electrodes to a touch control circuit. The detection electrodes arrange and align to form a detection area. Whenever a contact object or a pointer such as user's finger(s) 107 or an electromagnetic and capacitive pen 105 approach or touch the detection electrodes, a capacitor is formed between the user's finger(s) 107 or the electromagnetic and capacitive pen 105 and the detection electrodes. The locations of the user's finger(s) 107 or the electromagnetic and capacitive pen 105 are identical to the positions of the detection electrodes being approached or touched, and the capacitances of the detection electrodes are altered due to the capacitor between the user's finger(s) 107 or the electromagnetic and capacitive pen 105 and the detection electrodes. Details of the capacitive type sensor layer will be further described in the following content.

The sensor coil 106 comprises at least one metal coil located on the peripheral area of the transparent substrate around the capacitive type sensor layer 104 and connecting to an electromagnetic control circuit. The sensor coil 106 receives signals from the electromagnetic and capacitive pen 105. Variations of tip pressure level, corresponding to whether the button is pressed as well as whether the electromagnetic pen tail eraser function is used, can be identified via the variations of the frequency of the signals from the electromagnetic and capacitive pen 105.

Since the touch panel 100 has electromagnetic sensitive and capacitive touch control functions, in one embodiment of the invention, the touch panel 100 determines and performs different touch control modes according to the type of touch control object and the distance d between the touch control object and the touch panel 100. The touch control object comprises an electromagnetic and capacitive pen, user's finger(s) or other conductive objects.

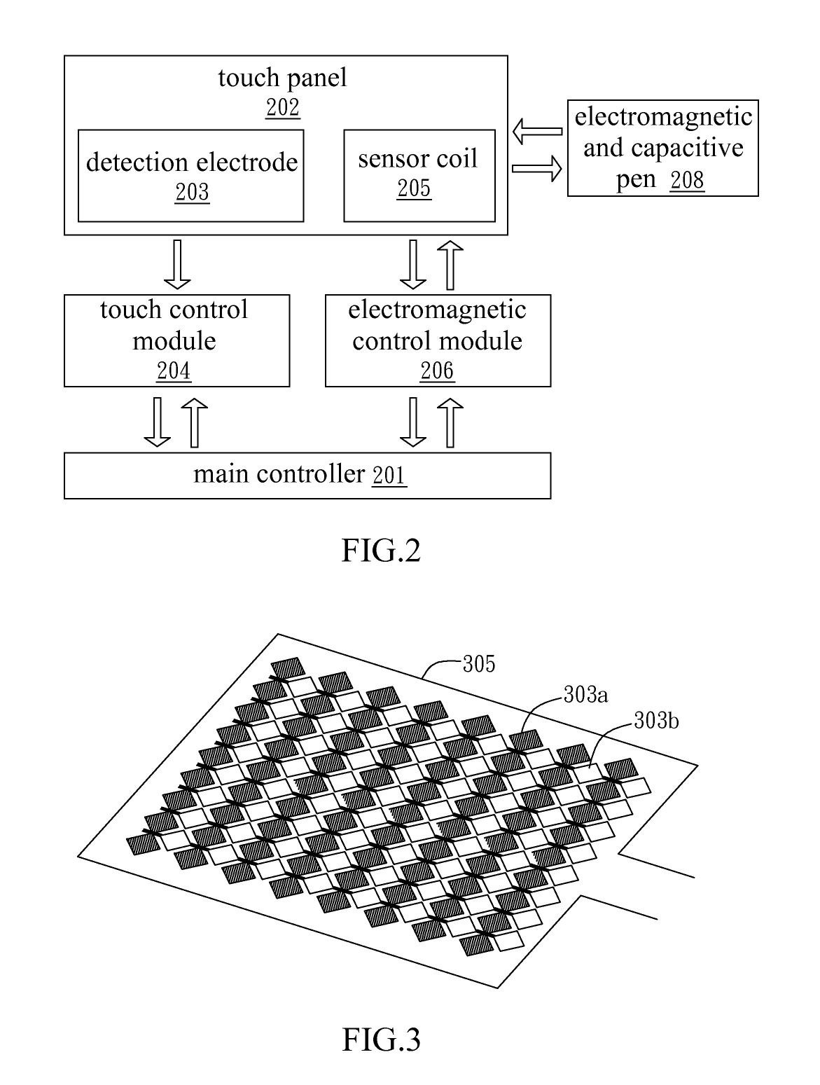

FIG. 2 shows a block diagram of a touch control display. The touch control display comprises a main controller 201, a touch panel 202, a touch control module 204 and an electromagnetic control module 206. An electromagnetic and capacitive pen 208, user's finger(s) or other conductive objects can be used to perform input operation on the touch control display. The touch panel 202 comprises detection electrodes 203 and at least one sensor coil 205.

The electromagnetic control module 206 is used to process signals received by the sensor coil 205 and from the electromagnetic and capacitive pen 208 so as to calculate the variations of frequency of the signals of the electromagnetic and capacitive pen 208 and to perform predetermined functions such as tip pressure level function, button function, etc. The touch control module 204 is utilized to process touch signals from the detection electrodes 203 to generate coordinates of the electromagnetic and capacitive pen 208, user's finger(s) or other conductive objects.

The electromagnetic control module 206 comprises 2-channel multiplexers, an amplifier and filter circuit, a sampling circuit and a micro-processor, etc. The touch control module 204 comprises multi-channel multiplexers, an amplifier and filter circuit, a sampling circuit and a micro-processor, etc. The main controller 201 integrates and processes the signals of tip pressure level and button being pressed resulting from variations of frequency of the signals of the electromagnetic and capacitive pen 208, and signals of coordinates of the electromagnetic and capacitive pen 208, user's finger(s) or other conductive objects according to the signals from the touch control module 204 and the electromagnetic control module 206.

The main controller 201 determines whether the touch control modes the touch panel 202 performs according to the sensor coil 205 and the electromagnetic control module 206 detect whether the electromagnetic and capacitive pen 208 exists. The main controller 201 also determines whether the touch control modes the touch panel 202 performs according to the detection electrodes 203 and the touch control module 204 detect whether conductive touch objects or indicators other than the electromagnetic and capacitive pen 208 exist. The main controller 201 also determines whether the touch control modes the touch panel 202 performs according to signal strength of conductive touch objects or indicators detected by the detection electrodes 203 and the touch control module 204. The detail content will be further described in the following description.

It is noted that the electromagnetic control module 206 and the touch control module 204 are not necessary separate elements but are different portions for performing different functions. The electromagnetic control module 206 and the touch control module 204 can be integrated into one element to be different portions for performing different functions.

An electromagnetic and capacitive pen comprises a conductive pin or pen core which can form a conductive path with user's hand holding the electromagnetic and capacitive pen so that the electromagnetic and capacitive pen can be used on the touch panel shown in FIG. 1. The conductive pin is usually movable to simulate tip pressure level variation. A typical design simulates tip pressure level variation through signal frequency variation of the electromagnetic and capacitive pen via the movement of the conductive pin. The signal frequency variation of the electromagnetic and capacitive pen usually is achieved by inductance variation of a resonance circuit of the electromagnetic and capacitive pen or capacitance variation of the resonance circuit of the electromagnetic and capacitive pen.

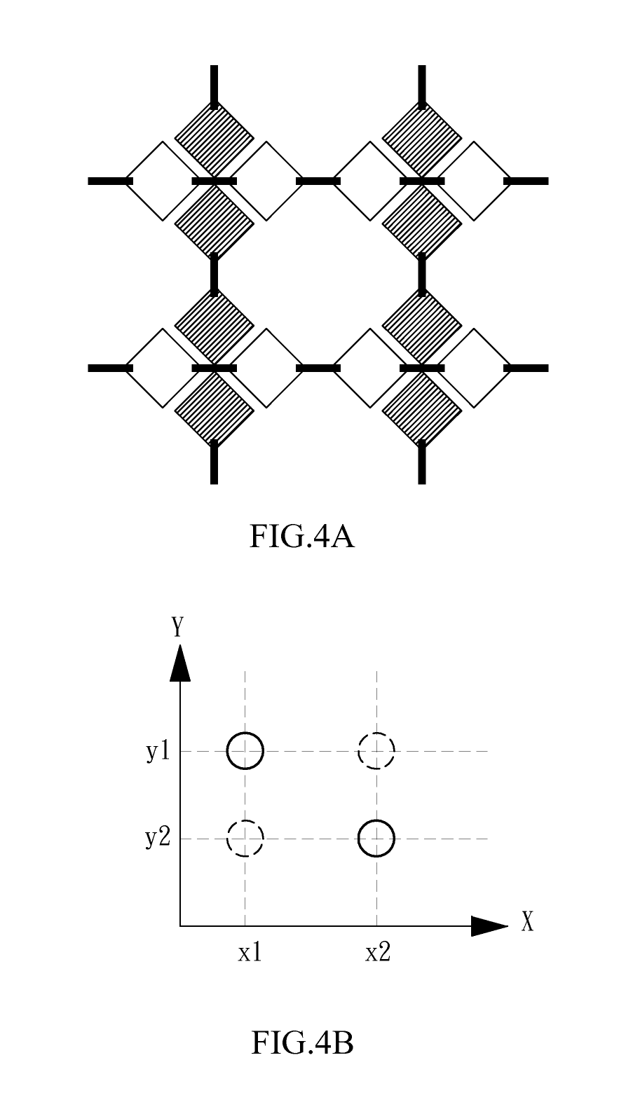

FIG. 3 shows a capacitive type substrate according to one embodiment of the invention. As shown in FIG. 3, a capacitive type touch panel comprises a touch control area or a detection area comprising detection electrodes 303a and 303b and a sensor coil 305 around the touch control area on a transparent substrate. In FIG. 3, traces connecting the detection electrodes 303a and 303b on the transparent substrate for transmitting signals are not shown. A detection electrodes matrix is formed by the detection electrodes 303a and 303b connecting by the traces in series respectively arranged and aligned along two substantially perpendicular to each other. The detection electrodes can be used as receive electrodes (Rx) and transmit electrodes (Tx).

As mentioned above, since the touch panel has electromagnetic sensitive and capacitive touch control functions, in the embodiment of the invention, the touch panel determines and performs different touch control modes according to the type of touch control object and the distance d between the touch control object and the touch panel. More particularly, the touch panel determines and performs single (dual) touch control mode and multi-touch control mode according to the type of touch control object and the distance d between the touch control object and the touch panel.

Since the location of a touch control object on a touch control area of a touch panel is obtained by calculating capacitance variation of detection electrodes being approached or touched resulting from capacitance between the touch control object and the detection electrodes, different capacitance calculation methods result in individual touch control modes respectively.

There are basically two methods for calculating capacitance of detection electrodes of a touch panel. One of the methods for calculating capacitance of detection electrodes of a touch panel is a self capacitance mode, and the other is a mutual capacitance mode. The self capacitance mode calculates capacitance variation of a series of detection electrodes along x axis or y axis, while the mutual capacitance mode calculates capacitance variation of a single cross point of two series of detection electrodes along x axis and y axis respectively.

The characteristics of detection electrode capacitance calculation of the self capacitance mode include detection signal formed from a relatively remote distance, high calculation speed and high switch rate to avoid noise, etc. However, multi-touch control is almost unavailable under the self capacitance mode. Ghost effect resulting from the calculation method of the detection electrode capacitance under the self capacitance mode renders a third point touch control unavailable under the self capacitance mode.

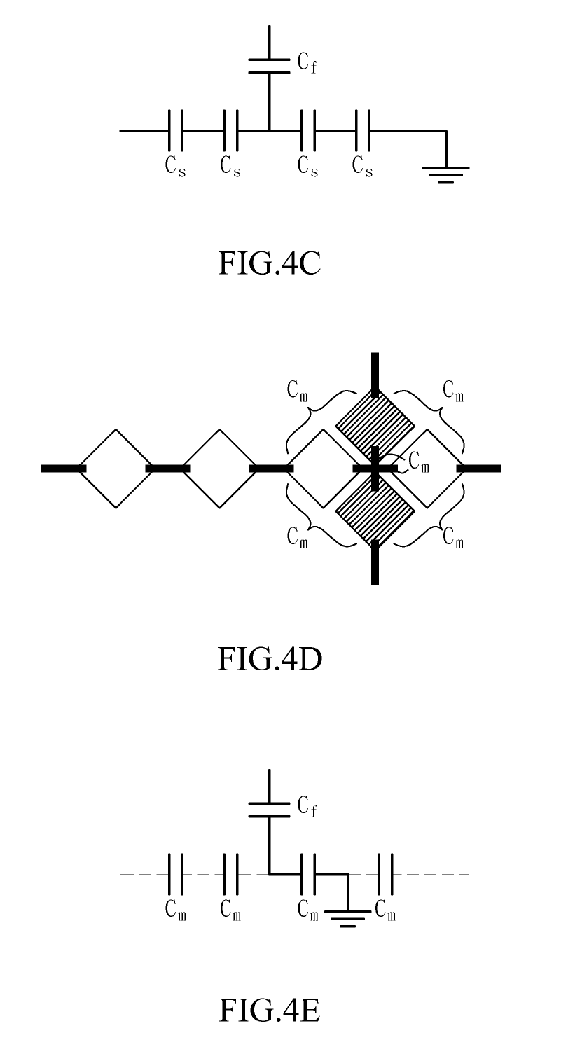

FIG. 4A and FIG. 4B show schematic diagrams of characteristics of self capacitance mode. When a single touch control is performed, a detection signal can be generated from a relatively remote distance since the self capacitance mode calculates capacitance variation of a series of detection electrodes along a single axis (x axis or y axis). However, when a dual touch control is performed, as shown in FIG. 4A and FIG. 4B, four detection channels x₁, x₂, y₁, y₂ of the touch control module will generate signals due to capacitance variations. If actual touch points are two points with coordinates (x₁, y₁) and (x₂, y₂), since all four points with coordinates (x₁, y₁), (x₂, y₂), (x₁, Y₂), and (x₂, y₁) are detected due to signals resulting from capacitance variations from the detection channels x₁, x₂, y₁, y₂, the touch control module under the self capacitance mode will not be able to determine which two points are the actual touch points, and thus a ghost effect of self capacitance mode will present.

FIG. 4C shows a schematic diagram of capacitance calculation of self capacitance mode. When a capacitance C_{f} of a touch object or an indicator such as a user's finger or an electromagnetic and capacitive pen is generated, the capacitance C_{f} is connected to a series of capacitances Cₛ and the total capacitance is the sum of all Cₛ and C_{f}. The capacitance C_{f} is in parallel connection with all Cₛ, and the total capacitance increases. Moreover, since it is all detection electrodes along a single axis which form capacitance with the touch object or an indicator, detection signal can be generated from a relatively remote distance under the self capacitance mode.

FIG. 4D shows schematic diagrams of characteristics of mutual capacitance mode. Mutual capacitance mode uses active scan such as simultaneously scanning capacitance variations of all axes (along y axis or x axis) while scanning capacitance variations of one axis (along x axis or y axis). After sequentially scanning all axes, capacitance variation of every detection electrode on every cross point of two intersecting axes along x axis and y axis respectively can be obtained so that ghost effect of the self capacitance mode can be avoided and a multi-touch control function is available under mutual capacitance mode. The total number of detection electrodes or touch points is only limited to the calculation capability of the touch control module.

FIG. 4E shows a schematic diagram of capacitance calculation of mutual capacitance mode. When a capacitance C_{f} of a touch object or an indicator such as a user's finger or an electromagnetic and capacitive pen is generated, the capacitance C_{f} is connected to a capacitance of Cₘ of a detection electrode on a cross point of two intersecting axes along x axis and y axis respectively and the total capacitance is the equivalent capacitance of Cₘ and C_{f} in serial connection. The capacitance C_{f} is a newly added capacitor connecting in serial and thus the total capacitance decreases. Since it is the detection electrode on a cross point of two intersecting axes along x axis and y axis respectively which form capacitance with the touch object or an indicator, detection signal can not be generated from a relatively remote distance under the mutual capacitance mode comparing to the self capacitance mode.

In one embodiment of the invention, the touch panel determines whether a single (dual) touch control mode or a multi-touch control mode are performed according to the type of touch control object and the distance between the touch control object and the touch panel. Referring to FIG. 1 and FIG. 2, through the characteristic of the long detecting range of electromagnetic signal between an electromagnetic and capacitive pen and the sensor coil, the main controller of the touch control display detects whether an electromagnetic and capacitive pen exists on the touch panel via the sensor coil and the electromagnetic control module. If signals of an electromagnetic and capacitive pen are detected, the main controller further performs tip pressure level function, button function and electromagnetic and capacitive pen tail eraser function according to frequency variation of signal from the electromagnetic and capacitive pen via the sensor coil and the electromagnetic control module. The main controller further performs a first touch control mode or a single (dual) touch control mode via the touch control module and the detection electrodes to calculate detection electrode capacitance under self capacitance mode.

If the sensor coil and the electromagnetic control module do not detect any signal from an electromagnetic and capacitive pen, the mail controller detects whether a conductive touch object or an indicator exists through the touch control module and the detection electrodes. If the conductive touch object or an indicator approaches to a distance close enough to generate a detection signal for the self capacitance mode to calculate capacitance variation of a series of detection electrodes along a single axis (x axis or y axis), the main controller will determine that a conductive touch object or an indicator exists. If the conductive touch object or an indicator approaches to a distance close enough to generate a detection signal for the mutual capacitance mode to calculate capacitance variation of a detection electrode on a cross point of two intersecting axes along x axis and y axis respectively, the main controller will also determine that a conductive touch object or an indicator exists.

The main controller then determines whether signal value from the conductive touch object or the indicator is over a threshold value through the touch control module and the detection electrodes. The threshold value is predetermined as the signal strength used to determine whether the self capacitance mode or the mutual capacitance mode are performed to calculate capacitance variation resulting from the conductive touch object or the indicator approaching the touch panel. When the detection signal value is large enough for performing the self capacitance mode to calculate capacitance variation but smaller than the threshold value, the main controller will determine and perform the self capacitance mode to calculate capacitance variation and to perform a first touch control mode or a single (dual) touch control mode. When the detection signal value is larger than the threshold value and enough for performing the mutual capacitance mode to calculate capacitance variation, the main controller will determine and perform the mutual capacitance mode to calculate capacitance variation and to perform a second touch control mode or a multi-touch control mode. By using active scan, all detection electrodes on all axes (along y axis or x axis) are sequentially scanned to detect capacitance variations and to perform the multi-touch control mode.

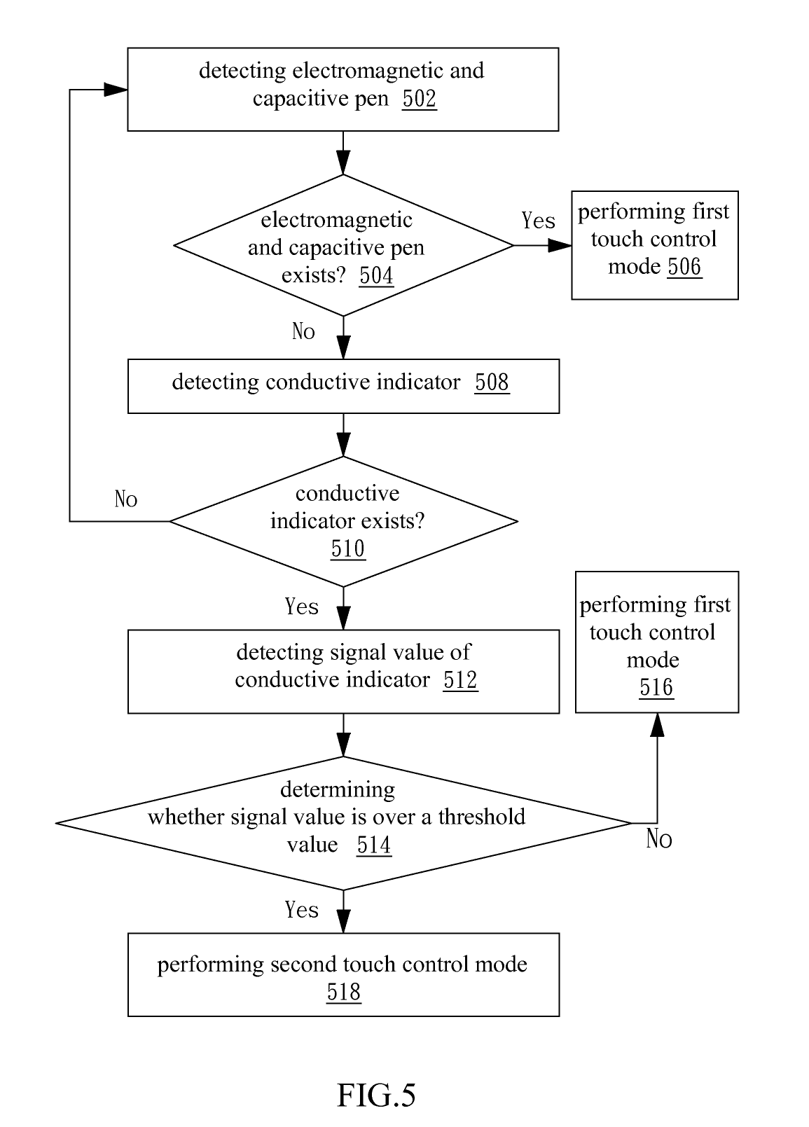

FIG. 5 is a flow chart of a control method for a touch panel according to one embodiment of the invention. First of all, a step 502 of detecting an electromagnetic and capacitive pen is performed. Then, in step 504, whether an electromagnetic and capacitive pen exists or not is determined. If the electromagnetic and capacitive pen exists, then in step 506, a first touch control mode is performed. If the electromagnetic and capacitive pen does not exist, then a step 508 of detecting a conductive indicator is performed. Next, in step 510, whether a conductive indicator exists or not is determined. If the conductive indicator does not exist, then step 502 is performed again. If the conductive indicator exists, then a step 512 of detecting signal value of the conductive indicator is performed. Next, a step 514 of determining whether the signal value is over a threshold value is performed to determine whether a first or a second touch control modes is performed. If the signal value is not over the threshold value, then in step 516, the first touch control mode is performed. Finally, if the signal value is over the threshold value, then in step 518, the second touch control mode is performed. In one embodiment of the invention, the control method for a touch panel can be built in as a firmware program of the main controller or a processor.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A control method for a touch panel, comprising:
detecting an electromagnetic and capacitive pen;
detecting a conductive indicator;
detecting a signal value of the conductive indicator; and
determining whether the signal value is over a threshold value to determine whether a first or a second touch control modes is performed, wherein the touch panel has electromagnetic sensitive and a capacitive touch control functions.

2. The control method according to claim 1, wherein the touch panel comprises a capacitive type sensor layer, at least one sensor coil on a transparent substrate, the capacitive type sensor layer comprises a plurality of detection electrodes, and the sensor coil is located on the peripheral area of the transparent substrate around the capacitive type sensor layer.

3. The control method according to claim 1, wherein the electromagnetic and capacitive pen comprises a conductive pin which can form a conductive path with a user's hand holding the electromagnetic and capacitive pen.

4. The control method according to claim 1, wherein the first touch control mode comprises a single (dual) touch control mode, and the second touch control mode comprises a multi-touch control mode.

5. The control method according to claim 4, wherein if the electromagnetic and capacitive pen exists, then the first touch control mode is performed.

6. The control method according to claim 4, wherein if the signal value is not over the threshold value, then the first touch control mode is performed.

7. The control method according to claim 4, wherein if the signal value is over the threshold value, then the second touch control mode is performed.

8. The control method according to claim 4, wherein the first touch control mode uses a self capacitance mode to calculate capacitance variation.

9. The control method according to claim 4, wherein the second touch control mode uses a mutual capacitance mode to calculate capacitance variation.

10. The control method according to claim 1, wherein if the conductive indicator does not exist, then the step of detecting an electromagnetic and capacitive pen is performed again.
